(19) United States
(12) Patent Application Publication
(10) Pub. No.: US 2022/0013812 A1
(43) Pub. Date: Jan. 13, 2022

(54) ELECTROLYTIC SOLUTION FOR SECONDARY BATTERY, AND SECONDARY BATTERY

(71) Applicant: MURATA MANUFACTURING CO., LTD., Kyoto (JP)

(72) Inventors: Tomomi SAKUMA, Kyoto (JP); Takuju HASHIMOTO, Kyoto (JP); Hideki NAKAI, Kyoto (JP)

(21) Appl. No.: 17/485,646

(22) Filed: Sep. 27, 2021

Related U.S. Application Data
(63) Continuation of application No. PCT/JP2020/010906, filed on Mar. 12, 2020.

(30) Foreign Application Priority Data
Mar. 29, 2019 (JP) 2019-065369

(51) Int. Cl. H01M 10/0569

(52) U.S. Cl. CPC H01M 10/0569; H01M 10/0525; H01M 2300/004

(57) ABSTRACT

A secondary battery includes a positive electrode, a negative electrode, and an electrolytic solution. The electrolytic solution includes a solvent and an electrolyte salt. The solvent includes a first ester compound and a second ester compound. The first ester compound is represented by R1-C(═O)—OR2, where each of R1 and R2 represents a first alkyl group, R1 has carbon number from 1 to 3 both inclusive, and the sum of the carbon number of R1 and the carbon number of R2 is from 3 to 5 both inclusive. The second ester compound is represented by R3O—FP(═O)—OR4, where each of R3 and R4 represents a second alkyl group, and the sum of the carbon number of R3 and the carbon number of R4 is from 2 to 10 both inclusive. The content of the first ester compound in the solvent is 30 vol % or more.

### CROSS REFERENCE TO RELATED APPLICATIONS

The present application is a continuation of PCT patent application no. PCT/JP2020/010906, filed on Mar. 12, 2020, which claims priority to Japanese patent application no. JP2019-065369 filed on Mar. 29, 2019, the entire contents of which are being incorporated herein by reference.

### BACKGROUND

The present technology generally relates to an electrolytic solution to be used for a secondary battery, and to a secondary battery using the electrolytic solution.

Various electronic apparatuses such as mobile phones have been widely used. Such widespread use has promoted development of a secondary battery as a power source that is smaller in size and lighter in weight and allows for a higher energy density. The secondary battery includes a positive electrode, a negative electrode, and an electrolytic solution.

A configuration of the electrolytic solution influences battery characteristics of the secondary battery. Accordingly, various considerations have been given to the configuration of the electrolytic solution. Specifically, in order to achieve a favorable capacity retention rate while securing long-term flame-retardancy, an oxo-acid ester derivative of phosphorus such as diethyl fluorophosphonate is included in the electrolytic solution. The electrolytic solution may further include aliphatic carboxylic acid esters such as ethyl propionate.

### SUMMARY

The present technology generally relates to an electrolytic solution to be used for a secondary battery, and to a secondary battery using the electrolytic solution.

Electronic apparatuses, on which a secondary battery is to be mounted, are increasingly gaining higher performance and more functions. This is causing more frequent use of such electronic apparatuses and expanding a use environment of the electronic apparatuses. Accordingly, there is still room for improvement in terms of battery characteristics of the secondary battery.

The present technology has been made in view of such an issue and it is an object of the technology to provide an electrolytic solution for a secondary battery, and a secondary battery that are each able to achieve a superior battery characteristic.

An electrolytic solution for a secondary battery according to an embodiment of the present technology includes a solvent and an electrolyte salt. The solvent includes a first ester compound represented by Formula (1) below and a second ester compound represented by Formula (2) below. The content of the first ester compound in the solvent is greater than or equal to 30 volume percent.

R1-C(═O)—OR2 (1)

where:
each of R1 and R2 represents a first alkyl group;
R1 has carbon number of greater than or equal to 1 and less than or equal to 3; and the sum of the carbon number of R1 and the carbon number of R2 is greater than or equal to 3 and less than or equal to 5.

R3O—FP(═O)—OR4 (2)

where:
each of R3 and R4 represents a second alkyl group; and
the sum of the carbon number of R3 and the carbon number of R4 is greater than or equal to 2 and less than or equal to 10.

A secondary battery according to an embodiment of the technology includes a positive electrode, a negative electrode, and an electrolytic solution. The electrolytic solution has a configuration similar to that of the electrolytic solution for a secondary battery according to the embodiment of the technology described herein.

According to the electrolytic solution for a secondary battery of the embodiment of the technology, or the secondary battery of the embodiment of the technology, the solvent of the electrolytic solution includes the first ester compound and the second ester compound, and the content of the first ester compound in the solvent is 30 vol % or more. This makes it possible to achieve a superior battery characteristic.

It should be understood that effects of the technology are not necessarily limited to those described above and may include any of a series of effects described below in relation to the technology.

### BRIEF DESCRIPTION OF THE FIGURES

FIG. 1 is a perspective view of a configuration of a secondary battery according to an embodiment of the present technology.

FIG. 2 is an enlarged sectional view of a configuration of a wound electrode body illustrated in FIG. 1.

FIG. 3 is a sectional view of a configuration of a secondary battery (a wound electrode body) according to an embodiment of the present technology.

### DETAILED DESCRIPTION

As described herein, the present disclosure will be described based on examples with reference to the drawings, but the present disclosure is not to be considered limited to the examples, and various numerical values and materials in the examples are considered by way of example.

A description is given first of a secondary battery according to an embodiment of the technology. An electrolytic solution for a secondary battery according to an embodiment of the technology is a portion or a component of the secondary battery described here, and is thus described together below. Hereinafter, the electrolytic solution for a second battery according to the embodiment of the technology is simply referred to as an “electrolytic solution”.

The secondary battery is a lithium-ion secondary battery that obtains a battery capacity by utilizing a lithium or lithium-ion insertion phenomenon and a lithium or lithium-ion extraction phenomenon, as will be described later. The secondary battery includes a positive electrode, a negative electrode, and an electrolytic solution. In the secondary battery, an electrochemical capacity per unit area of the negative electrode is greater than an electrochemical capacity per unit area of the positive electrode in order to prevent precipitation of lithium metal on a surface of the negative electrode in the middle of charging.

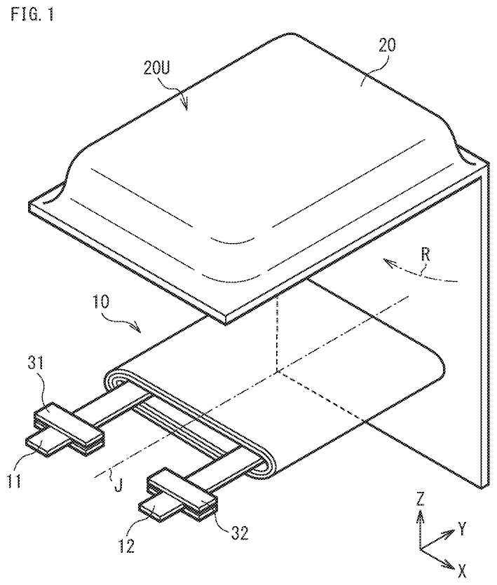

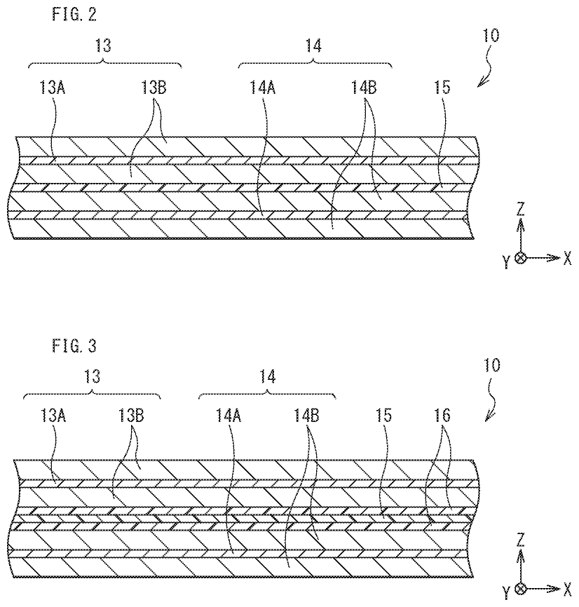

FIG. 1 is a perspective view of a configuration of the secondary battery. FIG. 2 is an enlarged sectional view of a configuration of a wound electrode body 10 illustrated in FIG. 1. It should be understood that FIG. 1 illustrates a state in which the wound electrode body 10 and an outer package member 20 are separated away from each other, and FIG. 2 illustrates only a portion of the wound electrode body 10.

In the secondary battery, as illustrated in FIG. 1, a battery device, i.e., the wound electrode body 10, is contained in the outer package member 20. The outer package member 20 is film-shaped and has softness or flexibility. A positive electrode lead 11 and a negative electrode lead 12 are coupled to the wound electrode body 10. Thus, the secondary battery described here is a secondary battery of a laminated-film type.

Referring to FIG. 1, the outer package member 20 is a single film that is foldable in a direction of an arrow R. The outer package member 20 has a depression 20U adapted to receive the wound electrode body 10. The outer package member 20 may be a polymer film, a metal foil, or a laminated film including a polymer film and a metal foil stacked on each other. In particular, the outer package member 20 is preferably a laminated film. A reason for this is that a sufficient sealing property and sufficient durability are obtainable.

Specifically, the outer package member 20 is a laminated film including a fusion-bonding layer, a metal layer, and a surface protective layer that are stacked in this order from an inner side. In the outer package member 20, outer edges of the fusion-bonding layer are fusion-bonded to each other. The fusion-bonding layer includes, for example, a polypropylene film. The metal layer includes, for example, an aluminum foil. The surface protective layer includes, for example, a nylon film.

It should be understood that the outer package member 20 may include two laminated films. In such a case, the respective outer edges of the fusion-bonding layers may be fusion-bonded to each other, or the two laminated films may be adhered to each other by means of an adhesive.

A sealing film 31 is interposed between the outer package member 20 and the positive electrode lead 11, and a sealing film 32 is interposed between the outer package member 20 and the negative electrode lead 12. The sealing films 31 and 32 each include a polypropylene film, for example.

As illustrated in FIGS. 1 and 2, the wound electrode body 10 includes a positive electrode 13, a negative electrode 14, a separator 15, and an electrolytic solution. The electrolytic solution is a liquid electrolyte. In the wound electrode body 10, the positive electrode 13 and the negative electrode 14 are stacked on each other with the separator 15 interposed therebetween, and the positive electrode 13, the negative electrode 14, and the separator 15 are wound. The positive electrode 13, the negative electrode 14, and the separator 15 are impregnated with the electrolytic solution. A surface of the wound electrode body 10 may be protected by means of, for example, an unillustrated protective tape.

As illustrated in FIG. 2, the positive electrode 13 includes a positive electrode current collector 13A, and a positive electrode active material layer 13B provided on each of both sides of the positive electrode current collector 13A. It should be understood that the positive electrode active material layer 13B may be provided only on one side of the positive electrode current collector 13A.

The positive electrode current collector 13A includes an electrically conductive material such as aluminum. The positive electrode active material layer 13B includes, as a positive electrode active material or positive electrode active materials, one or more of positive electrode materials into which lithium is insertable and from which lithium is extractable. The positive electrode active material layer 13B may further include another material, examples of which include a positive electrode binder and a positive electrode conductor.

The positive electrode material includes a lithium-containing compound. The lithium-containing compound is a compound that includes lithium and one or more transition metal elements as constituent elements. The lithium-containing compound is not limited to a particular kind, and examples thereof include a lithium composite oxide and a lithium phosphoric acid compound. Specifically, examples of a lithium composite oxide of a layered rock-salt type include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, and Li_{1.15}(Mn_{0.65}Ni_{0.22}Co_{0.13})O₂, Examples of a lithium composite oxide of a spinel type include LiMn₂O₄. Examples of a lithium phosphoric acid compound of an olivine type include LiFePO₄, LiMnPO₄, LiMn_{0.5}Fe_{0.5}PO₄, LiMn_{0.7}Fe_{0.3}PO₄, and LiMn_{0.75}Fe_{0.25}PO₄.

The positive electrode binder includes one or more of materials including, without limitation, a synthetic rubber and a polymer compound. Examples of the synthetic rubber include a styrene-butadiene-based rubber. Examples of the polymer compound include polyvinylidene difluoride and polyimide.

The positive electrode conductor includes one or more of electrically conductive materials including, without limitation, a carbon material. Examples of the carbon material include graphite, carbon black, acetylene black, and Ketj en black. It should be understood that the electrically conductive material may be a material such as a metal material or an electrically conductive polymer.

As illustrated in FIG. 2, the negative electrode 14 includes a negative electrode current collector 14A, and a negative electrode active material layer 14B provided on each of both sides of the negative electrode current collector 14A. It should be understood that the negative electrode active material layer 14B may be provided only on one side of the negative electrode current collector 14A.

The negative electrode current collector 14A includes an electrically conductive material such as copper. The negative electrode active material layer 14B includes, as a negative electrode active material or negative electrode active materials, one or more of negative electrode materials into which lithium is insertable and from which lithium is extractable. The negative electrode active material layer 14B may further include another material, examples of which include a negative electrode binder and a negative electrode conductor.

The negative electrode material includes one or more of materials including, without limitation, a carbon material and a metal-based material. Needless to say, the negative electrode material may include both of the carbon material and the metal-based material.

Specifically, examples of the carbon material include graphitizable carbon, non-graphitizable carbon, and graphite. The carbon material may be low-crystalline carbon or amorphous carbon. Examples of a shape of the carbon material include a fibrous shape, a spherical shape, a particulate shape, and a scale-like shape. The metal-based material is a material including, as a constituent element or constituent elements, one or more elements among metal elements and metalloid elements that are each able to form an alloy with lithium. The metal-based material may be a simple substance, an alloy, a compound such as an oxide, a mixture of two or more thereof, or a material including one or more phases thereof, and may include one or more non-metallic elements. Specifically, examples of the metal elements and the metalloid elements include magnesium, boron, aluminum, gallium, indium, silicon, germanium, tin, lead, bismuth, cadmium, silver, zinc, hafnium, zirconium, yttrium, palladium, and platinum.

Details of the negative electrode binder are similar to those of the positive electrode binder. Details of the negative electrode conductor are similar to those of the positive electrode conductor.

The separator 15 is interposed between the positive electrode 13 and the negative electrode 14. The separator 15 includes a porous film including one or more of materials including, without limitation, a synthetic resin and ceramic. The separator 15 may be a stacked film including two or more porous films stacked on each other. Examples of the synthetic resin include polyethylene.

The electrolytic solution includes a solvent and an electrolyte salt. It should be understood that the electrolytic solution may include only a single kind of solvent or two or more kinds of solvents. The electrolytic solution may include only a single kind of electrolyte salt or two or more kinds of electrolyte salts.

The solvent includes a first ester compound represented by Formula (1) below and a second ester compound represented by Formula (2) below. It should be understood that the solvent may include only a single kind of first ester compound or two or more kinds of first ester compounds. The solvent may include only a single kind of second ester compound or two or more kinds of second ester compounds.

R1-C(═O)—OR2 (1)

where:
each of R1 and R2 is a first alkyl group;
R1 has carbon number from 1 to 3 both inclusive; and
the sum of the carbon number of R1 and the carbon number of R2 is from 3 to 5 both inclusive.

R3O—FP(═O)—OR4 (2)

where:
each of R3 and R4 is second alkyl group; and
the sum of the carbon number of R3 and the carbon number of R4 is from 2 to 10 both inclusive.

The first alkyl group may be same as the second alkyl group in an embodiment. However, the first alkyl group may also be different from the second alkyl group according to another embodiment.

As is apparent from Formula (1), the first ester compound is a chain carboxylic-acid ester type compound in which two alkyl groups (R1 and R2) are bonded to an ester group (—C(═O)—). The alkyl groups may each be a straight-chain alkyl group or a branched-chain alkyl group having one or more side chains. In addition, R1 and R2 may be the same kind of alkyl groups or different kinds of alkyl groups.

It should be understood that as described above, R1 has carbon number from 1 to 3 both inclusive, and the sum of the carbon number of R1 and the carbon number of R2 is from 3 to 5 both inclusive. That is, R1 is an alkyl group and therefore formic acid esters, in which R1 is a hydrogen group, are excluded from the first ester compound described here. A reason for this is that formic acid esters have a strong reducing property. In view of these, specific examples of the first ester compound are as described below.

In a case where R1=1, the first ester compound is an acetic acid ester, and R2 =2 to 4. In this case, the first ester compound is any of ethyl acetate (R2=2), propyl acetate (R2=3), and butyl acetate (R2=4). Accordingly, methyl acetate (R2=1) is excluded from the first ester compound described here. A reason for this is that methyl acetate has high reactivity.

In a case where R1=2, the first ester compound is a propionic acid ester, and R2=1 to 3. In this case, the first ester compound is any of methyl propionate (R2=1), ethyl propionate (R2=2), and propyl propionate (R2=3).

In a case where R1=3, the first ester compound is a butyric acid ester, and R2=1 or 2. In this case, the first ester compound is either of methyl butyrate (R2=1) and ethyl butyrate (R2=2).

In particular, the first ester compound is preferably one or both of ethyl propionate and propyl propionate, and more preferably both of ethyl propionate and propyl propionate, that is, a mixture of ethyl propionate and propyl propionate.

As is apparent from Formula (2), the second ester compound is a fluorophosphonic-acid ester type compound in which a fluorine group (F) and two alkyl groups (R3 and R4) are bonded to a phosphorous atom of a phosphate bond (≡P═O). Details of the alkyl groups are as described above.

As described above, the sum of the carbon number of R3 and the carbon number of R4 is from 2 to 10 both inclusive. Therefore, R3 and R4 can each have carbon number ranging from 1 to 9 both inclusive. The carbon number of each of R3 and R4 is not particularly limited as long as the above-described condition related to the sum is satisfied. Accordingly, the second ester compound may have a symmetric structure or an asymmetric structure. In view of these, specific examples of the second ester compound are as described below.

In a case where R3=1, R4=1 to 9. In this case, the second ester compound is any of dimethyl fluorophosphonate (R4=1), methyl ethyl fluorophosphonate (R4=2), methyl propyl fluorophosphonate (R4=3), methyl butyl fluorophosphonate (R4=4), methyl pentyl fluorophosphonate (R4=5), methyl hexyl fluorophosphonate (R4=6), methyl heptyl fluorophosphonate (R4=7), methyl octyl fluorophosphonate (R4=8), and methyl nonyl fluorophosphonate (R4=9).

In a case where R3=2, R4=1 to 8. In this case, the second ester compound is any of ethyl methyl fluorophosphonate (R4=1), diethyl fluorophosphonate (R4=2), ethyl propyl fluorophosphonate (R4=3), ethyl butyl fluorophosphonate (R4=4), ethyl pentyl fluorophosphonate (R4=5), ethyl hexyl fluorophosphonate (R4=6), ethyl heptyl fluorophosphonate (R4=7), and ethyl octyl fluorophosphonate (R4=8).

In a case where R3=3, R4=1 to 7. In this case, the second ester compound is any of propyl methyl fluorophosphonate (R4=1), propyl ethyl fluorophosphonate (R4=2), dipropyl fluorophosphonate (R4=3), propyl butyl fluorophosphonate (R4=4), propyl pentyl fluorophosphonate (R4=5), propyl hexyl fluorophosphonate (R4=6), and propyl heptyl fluorophosphonate (R4=7).

In a case where R3=4, R4=1 to 6. In this case, the second ester compound is any of butyl methyl fluorophosphonate (R4=1), butyl ethyl fluorophosphonate (R4=2), butyl propyl fluorophosphonate (R4=3), dibutyl fluorophosphonate (R4=4), butyl pentyl fluorophosphonate (R4=5), and butyl hexyl fluorophosphonate (R4=6).

In a case where R3=5, R4=1 to 5. In this case, the second ester compound is any of pentyl methyl fluorophosphonate (R4=1), pentyl ethyl fluorophosphonate (R4=2), pentyl propyl fluorophosphonate (R4=3), pentyl butyl fluorophosphonate (R4=4), and dipentyl fluorophosphonate (R4=5).

In a case where R3=6, R4=1 to 4. In this case, the second ester compound is any of hexyl methyl fluorophosphonate (R4=1), hexyl ethyl fluorophosphonate (R4=2), hexyl propyl fluorophosphonate (R4=3), and hexyl butyl fluorophosphonate (R4=4).

In a case where R3=7, R4=1 to 3. In this case, the second ester compound is any of heptyl methyl fluorophosphonate (R4=1), heptyl ethyl fluorophosphonate (R4=2), and heptyl propyl fluorophosphonate (R4=3).

In a case where R3=8, R4=1 or 2. In this case, the second ester compound is either of octyl methyl fluorophosphonate (R4=1) and octyl ethyl fluorophosphonate (R4=2).

In a case where R3=9, R4=1. In this case, the second ester compound is nonyl methyl fluorophosphonate (R4=1).

It should be understood that in describing the foregoing series of specific examples of the second ester compound for each of cases with respective different values of R3, a series of compounds that is logically derived from the relationship between the carbon number of R3 and the carbon number of R4, i.e., the sum of the carbon number of R3 and the carbon number of R4, is listed in an all-inclusive manner. Therefore, compounds having substantially the same structure are included in the foregoing series of specific examples of the second ester compound. For example, methyl nonyl fluorophosphonate (R4=9) described for the case where R3=1 and nonyl methyl fluorophosphonate (R4=1) described for the case where R3=9 are the same compound.

In particular, R3 and R4 are preferably the same kind of alkyl groups, and therefore the second ester compound preferably has a bilaterally symmetric structure as a whole. Specifically, the second ester compound is preferably either one of diethyl fluorophosphonate and dipropyl fluorophosphonate.

The content of the second ester compound in the electrolytic solution is not particularly limited, whereas the content of the first ester compound in the electrolytic solution is set to fall within a predetermined range. Specifically, the content of the first ester compound in the solvent is 30 vol % or more.

A reason for the inclusion of the second ester compound together with the first ester compound in the solvent is that a decomposition reaction of the electrolytic solution is markedly suppressed by virtue of formation of a good film derived from the second ester compound on a surface of the positive electrode 13. It is considered that at the time of the film formation, with the fluorine group at the terminal in the second ester compound serving as a reaction point, the second ester compound forms a film in the presence of the first ester compound, while retaining all of its structure excluding the terminal, thereby resulting in a robust film with a superior anti-decomposition property. Excessive oxidative decomposition of the solvent in the positive electrode 13 is thereby suppressed. As a result, discharge capacity is prevented from decreasing easily and generation of gas is suppressed, even if charging and discharging of the secondary battery are repeatedly performed and the secondary battery is stored in a charged state. In this case, even in a severe environment such as a high-temperature environment, in particular, a decrease in discharge capacity is sufficiently suppressed and generation of gas is also sufficiently suppressed.

In view of the above, in a case where the solvent of the electrolytic solution includes the first ester compound and the second ester compound and where the content of the first ester compound in the solvent is 30 vol % or more, a decomposition reaction of the first ester compound is specifically suppressed, and therefore generation of gas is suppressed markedly with ion conductivity secured. This helps to continuously prevent discharge capacity from decreasing upon charging and discharging, and also helps to continuously prevent the secondary battery from swelling upon charging and discharging.

The content of the first ester compound in the solvent is preferably 70 vol %, in particular. A reason for this is that a decrease in discharge capacity is sufficiently suppressed and generation of gas is also sufficiently suppressed while ion conductivity is secured.

In addition, the content of the second ester compound in the electrolytic solution is preferably from 0.01 wt % to 5 wt % both inclusive, in particular. A reason for this is that a sufficiently robust film is formed to suppress decomposition of the first ester compound sufficiently.

It should be understood that the solvent may further include one or more of other solvents including, without limitation, a non-aqueous solvent (an organic solvent). An electrolytic solution including the non-aqueous solvent is a so-called non-aqueous electrolytic solution. The first ester compound and the second ester compound described above are excluded from the other solvents (non-aqueous solvents) described here.

The non-aqueous solvent is not limited to a particular kind, and examples thereof include a cyclic carbonic acid ester, a chain carbonic acid ester, a lactone, and a mononitrile compound. Examples of the cyclic carbonic acid ester include ethylene carbonate and propylene carbonate. Examples of the chain carbonic acid ester include dimethyl carbonate, diethyl carbonate, and methyl ethyl carbonate. Examples of the lactone include γ-butyrolactone and γ-valerolactone. Examples of the mononitrile compound include acetonitrile, methoxy acetonitrile, and 3-methoxy propionitrile.

Further examples of the non-aqueous solvent include an unsaturated cyclic carbonic acid ester, a halogenated carbonic acid ester, a sulfonic acid ester, an acid anhydride, a dinitrile compound, a diisocyanate compound, and a phosphoric acid ester. Examples of the unsaturated cyclic carbonic acid ester include vinylene carbonate, vinyl ethylene carbonate, and methylene ethylene carbonate. Examples of the halogenated carbonic acid ester include 4-fluoro-1,3-dioxolane-2-one, 4,5-difluoro-1,3-dioxolane-2-one, and fluoromethyl methyl carbonate. Examples of the sulfonic acid ester include 1,3-propane sultone and 1,3-propene sultone. Examples of the acid anhydride include succinic anhydride, glutaric anhydride, maleic anhydride, ethane disulfonic anhydride, propane disulfonic anhydride, sulfobenzoic anhydride, sulfopropionic anhydride, and sulfobutyric anhydride. Examples of the dinitrile compound include succinonitrile, glutaronitrile, adiponitrile, and phthalonitrile. Examples of the diisocyanate compound include hexamethylene diisocyanate. Examples of the phosphoric acid ester include trimethyl phosphate and triethyl phosphate.

The non-aqueous solvent preferably includes a cyclic carbonic acid ester, in particular. A reason for this is that the cyclic carbonic acid ester has a high viscosity, that is, a high dielectric constant, thus serving to improve a dissociation property of the electrolyte salt. In this case, the non-aqueous solvent may further include a chain carbonic acid ester. A reason for this is that the chain carbonic acid ester has a low viscosity, thus serving to improve ion conductivity.

The electrolyte salt includes one or more of light metal salts including, without limitation, a lithium salt. Specifically, examples of the lithium salt include lithium hexafluorophosphate, lithium tetrafluoroborate, lithium hexafluoroarsenate, lithium perchlorate, lithium trifluoromethanesulfonate, lithium bis(fluorosulfonyl)imide, lithium bis(trifluoromethane sulfonyl)imide, lithium bis(pentafluoroethane sulfonyl)imide, lithium tris(trifluoromethane sulfonyl)methyl, lithium chloride, lithium bromide, lithium fluorophosphate, lithium difluorophosphate, and lithium bis(oxalato)borate. The content of the electrolyte salt is from 0.3 mol/kg to 3.0 mol/kg both inclusive with respect to the solvent, but is not particularly limited thereto.

The positive electrode lead 11 is coupled to the positive electrode 13 (the positive electrode current collector 13A), and is led out from inside to outside of the outer package member 20. The positive electrode lead 11 includes an electrically conductive material such as aluminum, and has a shape such as a thin plate shape or a meshed shape.

The negative electrode lead 12 is coupled to the negative electrode 14 (the negative electrode current collector 14A), and is led out from inside to outside of the outer package member 20. The direction in which the negative electrode lead 12 is led out is similar to that in which the positive electrode lead 11 is led out. The negative electrode lead 12 includes an electrically conductive material such as nickel, and has a shape similar to that of the positive electrode lead 11.

Upon charging the secondary battery, lithium ions are extracted from the positive electrode 13 and the extracted lithium ions are inserted into the negative electrode 14 via the electrolytic solution. Further, upon discharging the secondary battery, lithium ions are extracted from the negative electrode 14, and the extracted lithium ions are inserted into the positive electrode 13 via the electrolytic solution.

In a case of manufacturing the secondary battery, as described below, the positive electrode 13 and the negative electrode 14 are fabricated and the electrolytic solution is prepared, following which the secondary battery is assembled using the positive electrode 13, the negative electrode 14, and the electrolytic solution.

First, the positive electrode active material, the positive electrode binder, and the positive electrode conductor are mixed together to obtain a positive electrode mixture. Thereafter, the positive electrode mixture is put into a solvent such as an organic solvent to thereby prepare a paste positive electrode mixture slurry. Lastly, the positive electrode mixture slurry is applied on both sides of the positive electrode current collector 13A to thereby form the positive electrode active material layers 13B. Thereafter, the positive electrode active material layers 13B may be compression-molded by means of a machine such as a roll pressing machine. In this case, the positive electrode active material layers 13B may be heated. The positive electrode active material layers 13B may be compression-molded a plurality of times. Thus, the positive electrode active material layers 13B are formed on both sides of the positive electrode current collector 13A. As a result, the positive electrode 13 is obtained.

The negative electrode active material layers 14B are formed on both sides of the negative electrode current collector 14A by a procedure similar to the fabrication procedure of the positive electrode 13 described above. Specifically, the negative electrode active material, the negative electrode binder, and the negative electrode conductor are mixed together to obtain a negative electrode mixture, following which the negative electrode mixture is put into a solvent such as an organic solvent or an aqueous solvent to thereby prepare a paste negative electrode mixture slurry. Thereafter, the negative electrode mixture slurry is applied on both sides of the negative electrode current collector 14A to thereby form the negative electrode active material layers 14B. Thereafter, the negative electrode active material layers 14B may be compression-molded. Thus, the negative electrode active material layers 14B are formed on both sides of the negative electrode current collector 14A. As a result, the negative electrode 14 is obtained.

The solvent including the first ester compound and the second ester compound is prepared, following which the electrolyte salt is put into the solvent. In this case, the content of the first ester compound in the solvent is set to 30 vol% or more. This allows the first ester compound and the second ester compound to be dispersed in the solvent, and also allows the electrolyte salt to be dissolved in the solvent. As a result, the electrolytic solution is prepared.

First, the positive electrode lead 11 is coupled to the positive electrode 13 (the positive electrode current collector 13A) by a method such as a welding method, and the negative electrode lead 12 is coupled to the negative electrode 14 (the negative electrode current collector 14A) by a method such as a welding method. Thereafter, the positive electrode 13 and the negative electrode 14 are stacked on each other with the separator 15 interposed therebetween, following which the positive electrode 13, the negative electrode 14, and the separator 15 are wound to thereby form a wound body.

Thereafter, the outer package member 20 is folded in such a manner as to sandwich the wound body, following which the outer edges on three sides of the outer package member 20 are bonded to each other by a method such as a thermal fusion bonding method to thereby allow the wound body to be contained in the pouch-shaped outer package member 20. Lastly, the electrolytic solution is injected into the pouch-shaped outer package member 20, following which the outer edges on the remaining one side of the outer package member 20 are bonded to each other by a method such as a thermal fusion bonding method to thereby seal the outer package member 20. In this case, the sealing film 31 is interposed between the outer package member 20 and the positive electrode lead 11, and the sealing film 32 is interposed between the outer package member 20 and the negative electrode lead 12. The wound body is thereby impregnated with the electrolytic solution. As a result, the wound electrode body 10 is formed. The wound electrode body 10 is thus contained in the outer package member 20. As a result, the secondary battery is completed.

According to this secondary battery, the solvent of the electrolytic solution includes the first ester compound and the second ester compound, and the content of the first ester compound in the solvent is 30 vol % or more. In this case, as described above, the robust film derived from the second ester compound is formed on the surface of the positive electrode 13 in the presence of the first ester compound, thereby suppressing a decomposition reaction of the electrolytic solution markedly. Accordingly, discharge capacity is prevented from decreasing easily and generation of gas is suppressed, even if charging and discharging of the secondary battery are repeatedly performed and the secondary battery is stored in a charged state. It is thus possible to achieve superior battery characteristics.

In particular, the content of the first ester compound in the solvent may be 70 vol % or less. This sufficiently suppresses a decrease in discharge capacity, and also sufficiently suppresses generation of gas, while securing an ion conductivity characteristic. Accordingly, it is possible to achieve higher effects.

Further, the content of the second ester compound in the electrolytic solution may be from 0.01 wt % to 5 wt % both inclusive. This sufficiently suppresses decomposition of the first ester compound, making it possible to achieve higher effects.

The solvent may further include a cyclic carbonic acid ester. This improves the dissociation property of the electrolyte salt, making it possible to achieve higher effects.

The above-described configuration of the secondary battery is appropriately modifiable, as will be described below. It should be understood that any two or more of the following series of modifications may be combined.

FIG. 3 illustrates a sectional configuration of a secondary battery (wound electrode body 10) according to Modification 1, and corresponds to FIG. 2. An electrolytic solution, i.e., a liquid electrolyte, is used in FIG. 2; however, as illustrated in FIG. 3, an electrolyte layer 16 may be used instead of the electrolytic solution. The electrolyte layer 16 is a gel electrolyte.

In the wound electrode body 10 including the electrolyte layer 16, the positive electrode 13 and the negative electrode 14 are stacked on each other with the separator 15 and the electrolyte layer 16 interposed therebetween, and the positive electrode 13, the negative electrode 14, the separator 15, and the electrolyte layer 16 are wound. The electrolyte layer 16 is interposed between the positive electrode 13 and the separator 15, and between the negative electrode 14 and the separator 15.

Specifically, the electrolyte layer 16 includes an electrolytic solution and a polymer compound. In the electrolyte layer 16, the electrolytic solution is held by the polymer compound. The electrolytic solution has the configuration as described above. The polymer compound may be a homopolymer such as polyvinylidene difluoride, or a copolymer such as a copolymer of vinylidene fluoride and hexafluoropylene, or may include both the homopolymer and the copolymer. In a case of forming the electrolyte layer 16, a precursor solution including, without limitation, the electrolytic solution, the polymer compound, and an organic solvent is prepared and thereafter, the precursor solution is applied on each of the positive electrode 13 and the negative electrode 14.

In this case also, lithium ions are movable between the positive electrode 13 and the negative electrode 14 via the electrolyte layer 16. Accordingly, it is possible to achieve similar effects.

The separator 15 may include a base layer, and a polymer compound layer provided on each of both sides of the base layer. It should be understood that the polymer compound layer may be provided only on one side of the base layer.

The base layer is the porous film described above. The polymer compound layer includes a polymer compound such as polyvinylidene difluoride. A reason for this is that such a polymer compound has superior physical strength and is electrochemically stable. It should be understood that the polymer compound layer may include inorganic particles. A reason for this is that, upon heat generation in the secondary battery, the inorganic particles release the heat, thus contributing to improved safety of the secondary battery. The inorganic particles are not limited to a particular kind, and examples thereof include insulating particles of a material such as aluminum oxide or aluminum nitride. In a case of forming the separator 15, a precursor solution including, without limitation, the polymer compound and an organic solvent is prepared and thereafter, the precursor solution is applied on both sides of the base layer.

In this case also, the positive electrode 13 and the negative electrode 14 are separated from each other with the separator 15 interposed therebetween. Accordingly, it is possible to achieve similar effects.

Applications of the secondary battery are not particularly limited as long as they are, for example, machines, apparatuses, instruments, devices, or systems (assemblies of a plurality of apparatuses, for example) in which the secondary battery is usable as a driving power source, an electric power storage source for electric power accumulation, or any other source. The secondary battery used as a power source may serve as a main power source or an auxiliary power source. The main power source is preferentially used regardless of the presence of any other power source. The auxiliary power source may be used in place of the main power source, or may be switched from the main power source on an as-needed basis. In a case where the secondary battery is used as the auxiliary power source, the kind of the main power source is not limited to the secondary battery.

Specifically, the applications of the secondary battery include: electronic apparatuses including portable electronic apparatuses; portable life appliances; storage devices; electric power tools; battery packs mountable on laptop personal computers or other apparatuses as detachable power sources; medical electronic apparatuses; electric vehicles; and electric power storage systems. Examples of the electronic apparatuses include video cameras, digital still cameras, mobile phones, laptop personal computers, cordless phones, headphone stereos, portable radios, portable televisions, and portable information terminals. Examples of the portable life appliances include electric shavers. Examples of the storage devices include backup power sources and memory cards. Examples of the electric power tools include electric drills and electric saws. Examples of the medical electronic apparatuses include pacemakers and hearing aids. Examples of the electric vehicles include electric automobiles including hybrid automobiles. Examples of the electric power storage systems include home battery systems for accumulation of electric power for emergency. Needless to say, the secondary battery may have applications other than those described above.

### EXAMPLES

Examples of the technology are described below.

### Experiment Examples 1-1 To 1-15

As described below, secondary batteries of the laminated-film type illustrated in FIGS. 1 and 2 were fabricated, and thereafter the fabricated secondary batteries were evaluated for battery characteristics.

In a case of fabricating the positive electrode 13, first, 91 parts by mass of the positive electrode active material (lithium cobalt oxide (LiCoO₂)), 3 parts by mass of the positive electrode binder (polyvinylidene difluoride), and 6 parts by mass of the positive electrode conductor (graphite) were mixed together to obtain a positive electrode mixture. Thereafter, the positive electrode mixture was put into an organic solvent (N-methyl-2-pyrrolidone), following which the organic solvent was stirred to obtain a paste positive electrode mixture slurry. Thereafter, the positive electrode mixture slurry was applied on both sides of the positive electrode current collector 13A (a band-shaped aluminum foil having a thickness of 12 μm) by means of a coating apparatus, following which the applied positive electrode mixture slurry was dried to thereby form the positive electrode active material layers 13B. Lastly, the positive electrode active material layers 13B were compression-molded by means of a roll pressing machine.

In a case of fabricating the negative electrode 14, first, 90 parts by mass of the negative electrode active material (graphite) and 10 parts by mass of the negative electrode binder (polyvinylidene difluoride) were mixed together to obtain a negative electrode mixture. Thereafter, the negative electrode mixture was put into an organic solvent (N-methyl-2-pyrrolidone), following which the organic solvent was stirred to obtain a paste negative electrode mixture slurry. Thereafter, the negative electrode mixture slurry was applied on both sides of the negative electrode current collector 14A (a band-shaped copper foil having a thickness of 15 μm) by means of a coating apparatus, following which the applied negative electrode mixture slurry was dried to thereby form the negative electrode active material layers 14B. Lastly, the negative electrode active material layers 14B were compression-molded by means of a roll pressing machine.

In a case of preparing the electrolytic solution, to a solvent (ethylene carbonate and propylene carbonate, which are cyclic carbonic acid esters) was added another solvent (the first ester compound), following which a mixture of the solvents (a mixed solvent) was stirred. In this case, a mixture ratio (a volume ratio) between ethylene carbonate, propylene carbonate, and the first ester compound in the mixed solvent was set to 20:10:70. The kinds and contents (vol %) of the first ester compound were as listed in Table 1. Thereafter, the electrolyte salt (lithium hexafluorophosphate) was added to the mixed solvent, following which the mixed solvent was stirred. In this case, the electrolyte salt content was set to 1 mol/kg with respect to the mixed solvent. Lastly, a still another solvent, i.e., the second ester compound, was added to the mixed solvent including the electrolyte salt, following which the resulting mixed solvent was stirred. The kind of the second ester compound and the content (wt %) of the second ester compound in the electrolytic solution were as listed in Table 1.

In this case, for the sake of comparison, electrolytic solutions were prepared by similar procedures except that the first ester compounds were replaced with other compounds. Such other compounds were as listed in Table 1.

In order to facilitate understanding of the configuration of each of the first ester compounds and the other compounds, Table 1 lists the respective carbon numbers of R1 and R2 of Formula (1) and also the sum of the carbon number of R1 and the carbon number of R2. Among a series of compounds listed under the column of “First ester compound or other compound”, compounds that satisfy the requirements described in relation to Formula (1), i.e., the requirements that the carbon number of R1 be from 1 to 3 both inclusive and that the sum of the carbon number of R1 and the carbon number of R2 be from 3 to 5 both inclusive, fall under the first ester compound, whereas compounds failing to satisfy the requirements described in relation to Formula (1) fall under the other compound. Examples of the first ester compound include ethyl acetate. Examples of the other compound include methyl formate.

In a case of assembling the secondary battery, first, the positive electrode lead 11 including aluminum was welded to the positive electrode current collector 13A, and the negative electrode lead 12 including copper was welded to the negative electrode current collector 14A. Thereafter, the positive electrode 13 and the negative electrode 14 were stacked on each other with the separator 15 (a fine-porous polyethylene film having a thickness of 15 μm) interposed therebetween to thereby obtain a stacked body. Thereafter, the stacked body was wound, following which a protective tape was attached to a surface of the stacked body to thereby obtain a wound body.

Thereafter, the outer package member 20 was folded in such a manner as to sandwich the wound body, following which the outer edges on two sides of the outer package member 20 were thermal fusion bonded to each other. As the outer package member 20, an aluminum laminated film was used in which a fusion-bonding layer (a polypropylene film having a thickness of 30 μm), a metal layer (an aluminum foil having a thickness of 40 μm), and a surface protective layer (a nylon film having a thickness of 25 μm) were stacked in this order from the inner side. In this case, the sealing film 31 (a polypropylene film having a thickness of 5 μm) was interposed between the outer package member 20 and the positive electrode lead 11, and the sealing film 32 (a polypropylene film having a thickness of 5 μm) was interposed between the outer package member 20 and the negative electrode lead 12.

Lastly, the electrolytic solution was injected into the outer package member 20 and thereafter, the outer edges on the remaining one side of the outer package member 20 were thermal fusion bonded to each other in a reduced-pressure environment. Thus, the wound body was impregnated with the electrolytic solution to thereby form the wound electrode body 10, and the wound electrode body 10 was sealed in the outer package member 20. As a result, the secondary battery of the laminated-film type was completed.

The secondary batteries were evaluated for battery characteristics, i.e., a low-current cyclability characteristic, a high-current cyclability characteristic, and a swelling characteristic. The evaluation results are presented in Table 1.

In a case of examining the low-current cyclability characteristic, first, the secondary battery was charged and discharged for one cycle in an ambient temperature environment (temperature=23° C.) in order to stabilize the state of the secondary battery. Thereafter, the secondary battery was charged and discharged for another cycle in the same environment, and the discharge capacity (i.e., the second-cycle discharge capacity) was measured. Thereafter, the secondary battery was charged and discharged for 100 cycles in the same environment, and the discharge capacity (i.e., the 102nd-cycle discharge capacity) was measured. Lastly, a low-current retention rate (%) was calculated as follows: low-current retention rate (%)=(102nd-cycle discharge capacity/second-cycle discharge capacity)×100.

Upon the charging, the secondary battery was charged with a constant current of 0.7 C until a voltage reached 4.45 V, and was thereafter charged with a constant voltage of 4.45 V until a current reached 0.05 C. Upon the discharging, the secondary battery was discharged with a constant current of 0.7 C until the voltage reached 2.5 V. 0.7 C is a value of a current that causes a battery capacity (a theoretical capacity) to be completely discharged in 10/7, and 0.05 C is a value of a current that causes the battery capacity to be completely discharged in 20 hours.

In a case of examining the high-current cyclability characteristic, a high-capacity retention rate (%) was calculated instead of the low-current retention rate (%) by a procedure similar to that in the case of examining the low-current cyclability characteristic, except that the current at the time of charging and the current at the time of discharging were each changed to 3.0 C. 3.0 C is a value of a current that causes the battery capacity to be completely discharged in 1/3.

In a case of examining the swelling characteristic, after the state of the secondary battery was stabilized by the above procedures, the secondary battery was first charged in an ambient temperature environment (temperature=23° C.), following which a thickness (a pre-storage thickness) of the secondary battery was measured. Thereafter, the secondary battery in the charged state was stored for one month in a high-temperature environment (temperature=60° C.), following which a thickness (a post-storage thickness) of the secondary battery was measured. Lastly, a swelling rate (%) was calculated as follows: swelling rate (%)=[(post-storage thickness—pre-storage thickness)/pre-storage thickness]×100. Charging conditions were similar to those in the case of examining the low-current cyclability characteristic.

TABLE 1

| | First ester compound | | | | | Second ester | | | | | Low- | High- | |
|---|---|---|---|---|---|---|---|---|---|---|---|---|---|
| | or other compound | | | | | compound | | | | | current | current | |
| | | Carbon | | | | | Carbon | | | | retention | retention | Swelling |
| Experiment | | number | | | Content | | number | | | Content | rate | rate | rate |
| example | Kind | R1 | R2 | Sum | (vol %) | Kind | R3 | R4 | Sum | (wt %) | (%) | (%) | (%) |
| 1-1 | Ethyl | 1 | 2 | 3 | 70 | Diethyl | 2 | 2 | 4 | 0.5 | 97 | 70 | 12 |
| | acetate | | | | | fluoro- | | | | | | | |
| 1-2 | Propyl | 1 | 3 | 4 | 70 | phosphonate | | | | | 96 | 69 | 10 |
| | acetate | | | | | | | | | | | | |
| 1-3 | Butyl | 1 | 4 | 5 | 70 | | | | | | 95 | 69 | 9.5 |
| | acetate | | | | | | | | | | | | |
| 1-4 | Methyl | 2 | 1 | 3 | 70 | | | | | | 96 | 81 | 11 |
| | propionate | | | | | | | | | | | | |
| 1-5 | Ethyl | 2 | 2 | 4 | 70 | | | | | | 99 | 87 | 6.2 |
| | propionate | | | | | | | | | | | | |
| 1-6 | Propyl | 2 | 3 | 5 | 70 | | | | | | 98 | 84 | 5.8 |
| | propionate | | | | | | | | | | | | |
| 1-7 | Ethyl | 2 | 2 | 4 | 40 | | | | | | 99 | 84 | 5.5 |
| | propionate + | | | | | | | | | | | | |
| | Propyl | 2 | 3 | 5 | 30 | | | | | | | | |
| | propionate | | | | | | | | | | | | |
| 1-8 | Methyl | 3 | 1 | 4 | 70 | | | | | | 93 | 75 | 9.2 |
| | butyrate | | | | | | | | | | | | |
| 1-9 | Ethyl | 3 | 2 | 5 | 70 | | | | | | 94 | 71 | 8.1 |
| | butyrate | | | | | | | | | | | | |
| 1-10 | Methyl | 0 | 1 | 1 | 70 | Diethyl | 2 | 2 | 4 | 0.5 | 71 | 33 | 22.8 |
| | formate | | | | | fluoro- | | | | | | | |
| 1-11 | Propyl | 0 | 3 | 3 | 70 | phosphonate | | | | | 86 | 48 | 20.4 |
| | formate | | | | | | | | | | | | |
| 1-12 | Methyl | 1 | 1 | 2 | 70 | | | | | | 88 | 54 | 15 |
| | acetate | | | | | | | | | | | | |
| 1-13 | Pentyl | 1 | 5 | 6 | 70 | | | | | | 90 | 56 | 14.4 |
| | acetate | | | | | | | | | | | | |
| 1-14 | Butyl | 2 | 4 | 6 | 70 | | | | | | 93 | 55 | 6.1 |
| | propionate | | | | | | | | | | | | |
| 1-15 | Propyl | 3 | 3 | 6 | 70 | | | | | | 92 | 60 | 6.2 |
| | butyrate | | | | | | | | | | | | |

As described in Table 1, the low-current retention rate, the high-current retention rate, and the swelling rate each varied depending on the composition of the electrolytic solution.

Specifically, in a case where the solvent of the electrolytic solution included the second ester compound together with the first ester compound (Experiment examples 1-1 to 1-9), a high low-current retention rate and a high high-current retention rate were obtained together with a low swelling rate, in contrast to a case where the solvent included the second ester compound together with a compound other than the first ester compound (Experiment examples 1-10 to 1-15).

### Experiment Examples 2-1 To 2-15

As described in Tables 2 and 3, secondary batteries were fabricated and evaluated for the battery characteristics by similar procedures, except that the kinds of the second ester compound were varied. In this case, for the sake of comparison, electrolytic solutions were prepared by similar procedures except that the second ester compounds were replaced with other compounds. Furthermore, for the sake of comparison, an electrolytic solution was prepared by a similar procedure except for using neither the second ester compound nor any of such other compounds. The other compounds mentioned above were as listed in Table 3.

In order to facilitate understanding of the configuration of each of the second ester compounds and the other compounds, Tables 2 and 3 list the respective carbon numbers of R3 and R4 of Formula (2) and also the sum of the carbon number of R3 and the carbon number of R4. Among a series of compounds listed under the column of “Second ester compound or other compound”, compounds that satisfy the requirement described in relation to Formula (2), i.e., the requirement that the sum of the carbon number of R3 and the carbon number of R4 be from 2 to 10 both inclusive, fall under the second ester compound, whereas compounds failing to satisfy the requirement described in relation to Formula (2) fall under the other compound. Examples of the second ester compound include dimethyl ethyl fluorophosphonate. Examples of the other compound include dihexyl fluorophosphonate.

TABLE 2

| | | | | | | | | | | | Low- | High- | |
|---|---|---|---|---|---|---|---|---|---|---|---|---|---|
| | First ester compound | | | | | Second ester compound | | | | | current | current | |
| | | Carbon | | | | | Carbon | | | | retention | retention | Swelling |
| Experiment | | number | | | Content | | number | | | Content | rate | rate | rate |
| example | Kind | R1 | R2 | Sum | (vol %) | Kind | R3 | R4 | Sum | (wt %) | (%) | (%) | (%) |
| 2-1 | Ethyl | 2 | 2 | 4 | 70 | Dimethyl | 1 | 1 | 2 | 0.5 | 97 | 80 | 5.6 |
| | propionate | | | | | fluoro- | | | | | | | |
| | | | | | | phosphonate | | | | | | | |
| 2-2 | | | | | | Methyl ethyl | 1 | 2 | 3 | 0.5 | 95 | 77 | 5.9 |
| | | | | | | fluoro- | | | | | | | |
| | | | | | | phosphonate | | | | | | | |
| 2-3 | | | | | | Methyl nonyl | 1 | 9 | 10 | 0.5 | 98 | 64 | 9.5 |
| | | | | | | fluoro- | | | | | | | |
| | | | | | | phosphonate | | | | | | | |
| 1-5 | | | | | | Diethyl | 2 | 2 | 4 | 0.5 | 99 | 87 | 6.2 |
| | | | | | | fluoro- | | | | | | | |
| | | | | | | phosphonate | | | | | | | |
| 2-4 | | | | | | Ethyl propyl | 2 | 3 | 5 | 0.5 | 95 | 76 | 6.1 |
| | | | | | | fluoro- | | | | | | | |
| | | | | | | phosphonate | | | | | | | |
| 2-5 | | | | | | Ethyl octyl | 2 | 8 | 10 | 0.5 | 94 | 66 | 9 |
| | | | | | | fluoro- | | | | | | | |
| | | | | | | phosphonate | | | | | | | |
| 2-6 | | | | | | Dipropyl | 3 | 3 | 6 | 0.5 | 96 | 73 | 6 |
| | | | | | | fluoro- | | | | | | | |
| | | | | | | phosphonate | | | | | | | |
| 2-7 | | | | | | Propyl heptyl | 3 | 7 | 10 | 0.5 | 96 | 71 | 6.9 |
| | | | | | | fluoro- | | | | | | | |
| | | | | | | phosphonate | | | | | | | |

TABLE 3

| | | | | | | Second ester compound | | | | | Low- | High- | |
|---|---|---|---|---|---|---|---|---|---|---|---|---|---|
| | First ester compound | | | | | or other compound | | | | | current | current | |
| | | Carbon | | | | | Carbon | | | | retention | retention | |
| Experiment | | number | | | Content | | number | | | Content | rate | rate | Swelling |
| example | Kind | R1 | R2 | Sum | (vol %) | Kind | R3 | R4 | Sum | (wt %) | (%) | (%) | (%) |
| 2-8 | Ethyl | 2 | 2 | 4 | 70 | Dibutyl | 4 | 4 | 8 | 0.5 | 98 | 81 | 7.7 |
| | propionate | | | | | fluoro- | | | | | | | |
| | | | | | | phosphonate | | | | | | | |
| 2-9 | | | | | | Butyl hexyl | 4 | 6 | 10 | 0.5 | 95 | 66 | 7.2 |
| | | | | | | fluoro- | | | | | | | |
| | | | | | | phosphonate | | | | | | | |
| 2-10 | | | | | | Dipentyl | 5 | 5 | 10 | 0.5 | 94 | 68 | 7.1 |
| | | | | | | fluoro- | | | | | | | |
| | | | | | | phosphonate | | | | | | | |
| 2-11 | Ethyl | 2 | 2 | 4 | 70 | — | — | — | — | — | 90 | 50 | 20.9 |
| 2-12 | propionate | | | | | Dihexyl | 6 | 6 | 12 | 0.5 | 91 | 58 | 12.1 |
| | | | | | | fluoro- | | | | | | | |
| | | | | | | phosphonate | | | | | | | |
| 2-13 | | | | | | Methyl decyl | 1 | 10 | 11 | 0.5 | 80 | 44 | 12.6 |
| | | | | | | fluoro- | | | | | | | |
| | | | | | | phosphonate | | | | | | | |
| 2-14 | | | | | | Ethyl nonyl | 2 | 9 | 11 | 0.5 | 81 | 49 | 11.8 |
| | | | | | | fluoro- | | | | | | | |
| | | | | | | phosphonate | | | | | | | |
| 2-15 | | | | | | Propyl octyl | 3 | 8 | 11 | 0.5 | 84 | 54 | 10.2 |
| | | | | | | fluoro- | | | | | | | |
| | | | | | | phosphonate | | | | | | | |

As described in Tables 2 and 3, in a case where the solvent of the electrolytic solution included the second ester compound together with the first ester compound (Experiment examples 1-5 and 2-1 to 2-10), the low-current retention rate and the high-current retention rate each increased and the swelling rate decreased, as compared with a case where the solvent included only the first ester compound (Experiment example 2-11) and a case where the solvent included a compound other than the second ester compound together with the first ester compound (Experiment examples 2-12 to 2-15).

### Experiment Examples 3-1 To 3-9

As described in Table 4, secondary batteries were fabricated and evaluated for the battery characteristics by similar procedures, except that the contents of the first ester compound were varied by varying the composition of the mixed solvent. In this case, ethylene carbonate (EC) and propylene carbonate (PC), which are cyclic carbonic acid esters, and additionally, in some cases, diethyl carbonate (DEC), which is a chain carbonic acid ester, were used as the solvent. Furthermore, for the sake of comparison, electrolytic solutions were prepared by similar procedures except that the second ester compound was replaced with another compound (diethyl chlorophosphonate).

TABLE 4

| | | | | | | | | | | | Low- | High- | |
|---|---|---|---|---|---|---|---|---|---|---|---|---|---|
| | Cyclic carbonic | | | | Chain carbonic | | First ester | | Second ester | | current | current | |
| | acid ester | | | | acid ester | | compound | | compound | | retention | retention | Swelling |
| Experiment | | Content | | Content | | Content | | Content | | Content | rate | rate | rate |
| example | Kind | (vol %) | Kind | (vol %) | Kind | (vol %) | Kind | (vol %) | Kind | (wt %) | (%) | (%) | (%) |
| 3-1 | EC | 20 | PC | 10 | DEC | 50 | Ethyl | 20 | Diethyl | 0.5 | 91 | 41 | 5.2 |
| 3-2 | EC | 20 | PC | 10 | DEC | 40 | propionate | 30 | fluoro- | | 94 | 73 | 5.1 |
| 3-3 | EC | 20 | PC | 10 | DEC | 20 | | 50 | phosphonate | | 96 | 82 | 5.5 |
| 1-5 | EC | 20 | PC | 10 | — | — | | 70 | | | 99 | 87 | 6.2 |
| 3-4 | EC | 10 | PC | 10 | — | — | | 80 | | | 94 | 75 | 6.5 |
| 3-5 | EC | 20 | PC | 10 | DEC | 50 | Ethyl | 20 | Diethyl | 0.5 | 92 | 49 | 12.7 |
| 3-6 | EC | 20 | PC | 10 | DEC | 40 | propionate | 30 | chloro- | | 93 | 53 | 13.4 |
| 3-7 | EC | 20 | PC | 10 | DEC | 20 | | 50 | phosphonate | | 93.5 | 55 | 15.5 |
| 3-8 | EC | 20 | PC | 10 | — | — | | 70 | | | 93 | 52 | 16.6 |
| 3-9 | EC | 10 | PC | 10 | — | — | | 80 | | | 91 | 50 | 17.3 |

As described in Table 4, in a case where the content of the first ester compound was less than 30 vol % (Experiment example 3-1), the high-current retention rate was low even if the solvent included the second ester compound together with the first ester compound, although a low swelling rate and a high low-current retention rate were obtained.

In contrast, in a case where the content of the first ester compound was 30 vol % or more (Experiment examples 1-5 and 3-2 to 3-4), the inclusion of the second ester compound together with the first ester compound in the solvent increased each of the low-current retention rate and the high-current retention rate while keeping the swelling rate low. In this case, a lower swelling rate was achieved while the low-current retention rate and the high-current retention rate were kept high in a case where the content of the first ester compound was 70 vol % or less, in particular.

A reason for this is considered to be as follows. In a case where both the first ester compound and the second ester compound are present and where the content of the first ester compound is 30 vol % or more, a robust film derived from the second ester compound is formed in the presence of the first ester compound as described above, thereby suppressing a decomposition reaction of the electrolytic solution markedly.

In a case where the second ester compound having a fluorine group was replaced with another compound having a chlorine group (Experiment examples 3-5 to 3-9), the low-current retention rate was high independently of the content of the first ester compound; however, the swelling rate increased and the high-current retention rate decreased, also independently of the content of the first ester compound.

A reason for this is considered to be that such another compound having a chlorine group is unable to perform a function similar to that of the second ester compound having a fluorine group, i.e., the function to suppress decomposition of the electrolytic solution, regardless of whether the content of the first ester compound is 30 vol% or more.

### Experiment Examples 4-1 To 4-6

As described in Table 5, secondary batteries were fabricated and evaluated for the battery characteristics by similar procedures, except that the contents of the second ester compound were varied.

TABLE 5

| | | | | | | | | | Low- | High- | |
|---|---|---|---|---|---|---|---|---|---|---|---|
| | Cyclic carbonic | | | | First ester | | Second ester | | current | current | |
| | acid ester | | | | compound | | compound | | retention | retention | Swelling |
| Experiment | | Content | | Content | | Content | | Content | rate | rate | rate |
| example | Kind | (vol %) | Kind | (vol %) | Kind | (vol %) | Kind | (wt %) | (%) | (%) | (%) |
| 2-11 | EC | 20 | PC | 10 | Ethyl | 70 | — | — | 90 | 50 | 20.9 |
| | | | | | propionate | | | | | | |
| 4-1 | EC | 20 | PC | 10 | Ethyl | 70 | Diethyl | 0.001 | 95 | 60 | 18.8 |
| 4-2 | | | | | propionate | | fluoro- | 0.01 | 96 | 73 | 11 |
| 4-3 | | | | | | | phosphonate | 0.1 | 96 | 78 | 7.4 |
| 1-5 | | | | | | | | 0.5 | 99 | 87 | 6.2 |
| 4-4 | | | | | | | | 1 | 98.5 | 80 | 7 |
| 4-5 | | | | | | | | 5 | 96.4 | 68 | 8.5 |
| 4-6 | | | | | | | | 10 | 91 | 51 | 10.1 |

As described in Table 5, in a case where the solvent of the electrolytic solution included the second ester compound, a high low-current retention rate and a high high-current retention rate were obtained together with a low swelling rate, independently of the content of the second ester compound.

In a case where the content of the second ester compound was from 0.01 wt % to 5 wt % both inclusive, in particular, a higher low-current retention rate and a higher high-current retention rate were obtained together with a lower swelling rate.

The results presented in Tables 1 to 5 indicate that in the case where the solvent of the electrolytic solution included the first ester compound and the second ester compound and where the content of the first ester compound in the solvent was 30 vol% or more, the low-current cyclability characteristic, the high-current cyclability characteristic, and the swelling characteristic were all improved. Accordingly, the secondary battery achieved superior battery characteristics.

Although the technology has been described above with reference to some embodiments and Examples, the embodiment of the technology is not limited to those described with reference to the embodiments and the Examples above, and is therefore modifiable in a variety of ways.

Specifically, although the description has been given with reference to the case where the secondary battery of the technology is of the laminated-film type, the secondary battery of the technology is not limited to a particular type. Specifically, the secondary battery of the technology may be of any other type, for example, a cylindrical type, a prismatic type, or a coin type. Further, although the description has been given with reference to the case where the battery device for use in the secondary battery of the technology has a wound structure, the structure of the battery device is not particularly limited. Specifically, the battery device may have any other structure such as a stacked structure.

The effects described herein are mere examples. Therefore, the effects of the technology are not limited to the effects described herein. Accordingly, the technology may achieve any other effect.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode; and
an electrolytic solution including a solvent and an electrolyte salt, the solvent including a first ester compound represented by Formula (1) and a second ester compound represented by Formula (2),
wherein a content of the first ester compound in the solvent is greater than or equal to 30 volume percent,
R1-C(═O)—OR2 (1)
wherein
each of R1 and R2 represents a first alkyl group,
R1 has carbon number of greater than or equal to 1 and less than or equal to 3, and
a sum of the carbon number of R1 and carbon number of R2 is greater than or equal to 3 and less than or equal to 5,
R3O—FP(═O)—OR4 (2)
wherein
each of R3 and R4 represents a second alkyl group, and
a sum of carbon number of R3 and carbon number of R4 is greater than or equal to 2 and less than or equal to 10.

2. The secondary battery according to claim 1, wherein the content of the first ester compound in the solvent is less than or equal to 70 volume percent.

3. The secondary battery according to claim 1, wherein a content of the second ester compound in the electrolytic solution is greater than or equal to 0.01 weight percent and less than or equal to 5 weight percent.

4. The secondary battery according to claim 2, wherein a content of the second ester compound in the electrolytic solution is greater than or equal to 0.01 weight percent and less than or equal to 5 weight percent.

5. The secondary battery according to claim 1, wherein the solvent further includes a cyclic carbonic acid ester.

6. The secondary battery according to claim 2, wherein the solvent further includes a cyclic carbonic acid ester.

7. The secondary battery according to claim 3, wherein the solvent further includes a cyclic carbonic acid ester.

8. The secondary battery according to claim 4, wherein the solvent further includes a cyclic carbonic acid ester.

9. An electrolytic solution for a secondary battery, the electrolytic solution comprising:
a solvent; and
an electrolyte salt, wherein
the solvent includes a first ester compound represented by Formula (1) and a second ester compound represented by Formula (2), and
wherein a content of the first ester compound in the solvent is greater than or equal to 30 volume percent,
R1-C(═O)—OR2 (1)
wherein
each of R1 and R2 represents a first alkyl group,
R1 has carbon number of greater than or equal to 1 and less than or equal to 3, and
a sum of the carbon number of R1 and carbon number of R2 is greater than or equal to 3 and less than or equal to 5,
R3O—FP(═O)—OR4 (2)
wherein
each of R3 and R4 represents a second alkyl group, and
a sum of carbon number of R3 and carbon number of R4 is greater than or equal to 2 and less than or equal to 10.
